(19) United States
(12) Patent Application Publication
(10) Pub. No.: US 2026/0225080 A1
(43) Pub. Date: Aug. 6, 2026

(54) HIGH-ENTROPY RUTHENIUM OXIDES AS EFFICIENT OXYGEN EVOLUTION REACTION CATALYSTS

(71) Applicant: Toyota Motor Engineering & Manufacturing North America, Inc., Plano, TX (US)

(72) Inventors: Siwen Wang, Livonia, MI (US); Chen Ling, Troy, MI (US); Li Qin Zhou, Okemos, MI (US); Charles A. Roberts, Farmington Hills, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/045,933

(22) Filed: Feb. 5, 2025

(51) Int. Cl. B01J 23/46; B01J 35/50; C25B 11/089

(52) U.S. Cl. CPC B01J 23/462; B01J 35/50; C25B 11/089; B01J 2523/17; B01J 2523/22; B01J 2523/27; B01J 2523/31; B01J 2523/32; B01J 2523/3706; B01J 2523/42; B01J 2523/67; B01J 2523/72; B01J 2523/821; B01J 2523/842; B01J 2523/845; B01J 2523/847

(57) ABSTRACT

An oxygen evolution reaction (OER) catalyst for reaction in acidic media comprising: a Ru(M1M2M3M4)O₂ catalyst, wherein the Ru(M1M2M3M4)O₂ catalyst comprises an M1, an M2, an M3 and an M4 co-doped in ruthenium oxide (RuO₂), wherein M1 is chosen from Cr, Fe, Co, Ni, Cu, Zi, Al, Ga, Ge, Mg, La and combinations thereof, wherein M2 is chosen from Cr, Fe, Co, Ni, Cu, Zi, Al, Ga, Ge, Mg, La and combinations thereof, wherein M3 is chosen from Cr, Fe, Co, Ni, Cu, Zi, Al, Ga, Ge, Mg, La and combinations thereof, and wherein M4 is chosen from Cr, Fe, Co, Ni, Cu, Zi, Al, Ga, Ge, Mg, La and combinations thereof.

### TECHNICAL FIELD

The present disclosure generally relates to an oxygen evolution reaction (OER) catalyst comprising: a Ru(M1M2M3M4)O₂ catalyst, wherein the Ru(M1M2M3M4)O₂ catalyst comprises an M1, an M2, an M3 and an M4 co-doped in ruthenium oxide (RuO₂), wherein M1 is chosen from Cr, Fe, Co, Ni, Cu, Zi, Al, Ga, Ge, Mg, La and combinations thereof, wherein M2 is chosen from Cr, Fe, Co, Ni, Cu, Zi, Al, Ga, Ge, Mg, La and combinations thereof, wherein M3 is chosen from Cr, Fe, Co, Ni, Cu, Zi, Al, Ga, Ge, Mg, La and combinations thereof, and wherein M4 is chosen from Cr, Fe, Co, Ni, Cu, Zi, Al, Ga, Ge, Mg, La and combinations thereof.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor implicitly admitted as prior art against the present technology.

Water electrolysis (WE) using the hydrogen evolution reaction is widely recognized as a promising method for clean and sustainable hydrogen production. Currently, the dominant alkaline-based water electrolysis methods encounter challenges such as high ohmic resistance, limited current density, low efficiency, and poor long-term stability.

Proton exchange membrane (PEM) electrolysis in acid condition provides efficient proton transfers and can effectively tackle the above challenges. Sluggish oxygen evolution reaction (OER) in acidic media has been a major long-existing obstacle in PEM systems and has therefore attracted great research interest.

IrO₂ (iridium oxide) is currently considered the only practical OER electrocatalyst in PEM electrolysis devices due to its high activity and durability. However, the high cost and low global reserve of Ir limit its large-scale applications. Less-expensive catalysts for acidic OER are in great demand.

RuO₂ (ruthenium oxide) has been recognized as an attractive alternative to IrO₂ for acidic OER due to its lower cost. The price of Ru is one-tenth that of Ir, and its earth abundance is about 100 times greater than that of Ir. While RuO₂ presents higher OER activity than IrO₂, its long-term stability remains a big challenge. In recent years, various strategies, i.e., lattice doping, strain effect, and morphology and structure modifications, have been tried to improve the performance of RuO₂ in acidic media.

### SUMMARY

This section provides a general summary of the disclosure and is not a comprehensive disclosure of its full scope or all of its features.

In various aspects, the present teachings provide oxygen evolution reaction (OER) catalyst comprising:

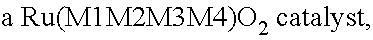

wherein the Ru(M1M2M3M4)O₂ catalyst comprises an M1, an M2, an M3 and an M4 co-doped in ruthenium oxide (RuO₂),
wherein M1 is chosen from Cr, Fe, Co, Ni, Cu, Zi, Al, Ga, Ge, Mg, La and combinations thereof,
wherein M2 is chosen from Cr, Fe, Co, Ni, Cu, Zi, Al, Ga, Ge, Mg, La and combinations thereof,
wherein M3 is chosen from Cr, Fe, Co, Ni, Cu, Zi, Al, Ga, Ge, Mg, La and combinations thereof, and
wherein M4 is chosen from Cr, Fe, Co, Ni, Cu, Zi, Al, Ga, Ge, Mg, La and combinations thereof.

In some aspects of the OER catalyst, Ru (ruthenium) ranges from about 20 at % (atomic percent) to about 99 at %, the M1 ranges from about 0.25 at % to about 20 at %, the M2 ranges from about 0.25 at % to about 20 at %, the M3 ranges from about 0.25 at % to about 20 at %, and the M4 ranges from about 0.25% to about 20 at %.

In yet another aspect the OER catalyst is Ru_{0.75}(M1M2M3M4)_{0.25}O₂.

In yet another aspect of the OER catalyst, the M1, the M2, the M3 and the M4 are in an identical proportion or in the same composition ratio in the Ru(M1M2M3M4)O₂ catalyst.

In yet another aspect, the OER catalyst is chosen from an Ru_{0.75}(CrMnFeGe)_{0.25}O₂ catalyst, an Ru_{0.75}(CrMnAlGe)_{0.25}O₂ catalyst, an Ru_{0.75}(CrMnGaGe)_{0.25}O₂ catalyst, an Ru_{0.75}(CrFeGaGe)_{0.25}O₂ catalyst, an Ru_{0.75}(CrCoMgLa)_{0.25}O₂ catalyst and an Ru_{0.75}(NiCuZnLa)_{0.25}O₂ catalyst.

In yet another aspect of the OER catalyst, an additional energy greater than 0 eV is required to remove one ruthenium (Ru) atom from the Ru(M1M2M3M4)O₂ catalyst as compared to undoped RuO₂.

In another aspect of the OER catalyst, an additional energy of about 2.189 eV is required to remove one ruthenium (Ru) atom from the Ru_{0.75}(CrMnFeGe)_{0.25}O₂ catalyst as compared to undoped RuO₂.

In another aspect of the OER catalyst, an additional energy of about 2.881 eV is required to remove one ruthenium (Ru) atom from the Ru_{0.75}(CrMnAlGe)_{0.25}O₂ catalyst as compared to undoped RuO₂.

In another aspect of the OER catalyst, an additional energy of about 4.526 eV is required to remove one ruthenium (Ru) atom from the Ru_{0.75}(CrMnGaGe)_{0.25}O₂ catalyst as compared to undoped RuO₂.

In another aspect of the OER catalyst, an additional energy of about 2.42 eV is required to remove one ruthenium (Ru) atom from the Ru_{0.75}(CrFeGaGe)_{0.25}O₂ catalyst as compared to undoped RuO₂.

In another aspect of the OER catalyst, an additional energy of about 1.585 eV is required to remove one ruthenium (Ru) atom from the Ru_{0.75}(CrCoMgLa)_{0.25}O₂ catalyst as compared to undoped RuO₂.

In another aspect of the OER catalyst, an additional energy of about 1.921 eV is required to remove one ruthenium (Ru) atom from the Ru_{0.75}(NiCuZnLa)_{0.25}O₂ catalyst as compared to undoped RuO₂.

In another aspect of the OER catalyst, a convex hull energy of an Ru_{0.75}(CrMnFeGe)_{0.25}O₂ catalyst ranges from 0 eV/atom to about 0.05 eV/atom, a convex hull energy of an Ru_{0.75}(CrMnAlGe)_{0.25}O₂ catalyst ranges from 0 eV/atom to about 0.05 eV/atom, a convex hull energy of an Ru_{0.75}(CrMnGaGe)_{0.25}O₂ catalyst ranges from 0 eV/atom to about 0.05 eV/atom, a convex hull energy of an Ru_{0.75}(CrFeGaGe)_{0.25}O₂ catalyst ranges from 0 eV/atom to about 0.05 eV/atom, a convex hull energy of an Ru_{0.75}(CrCoMgLa)_{0.25}O₂ catalyst ranges from 0 eV/atom to about 0.05 eV/atom and a convex hull energy of an Ru_{0.75}(NiCuZnLa)_{0.25}O₂ catalyst ranges from 0 eV/atom to about 0.05 eV/atom.

In another aspect of the OER catalyst, the convex hull energy of the Ru_{0.75}(CrMnFeGe)_{0.25}O₂ catalyst is about 0.026 eV/atom, the convex hull energy of the Ru_{0.75}(CrMnAlGe)_{0.25}O₂ catalyst is about 0.045 eV/atom, the convex hull energy of the Ru_{0.75}(CrMnGaGe)_{0.25}O₂ catalyst is about 0.043 eV/atom, the convex hull energy of the Ru_{0.75}(CrFeGaGe)_{0.25}O₂ catalyst is about 0.048 eV/atom, the convex hull energy of the Ru_{0.75}(CrCoMgLa)_{0.25}O₂ catalyst is about 0.049 eV/atom and the convex hull energy of the Ru_{0.75}(NiCuZnLa)_{0.25}O₂ catalyst is about 0.02 eV/atom.

In another aspect of the OER catalyst, the Ru(M1M2M3M4)O₂ catalyst is a solid solution metal oxide.

In these different aspects of the OER catalyst, the OER catalyst comprises a tetragonal rutile-type structure. The OER catalyst is at an anode of a proton exchange membrane (PEM) water electrolyzer. In these different aspects, the OER catalyst is applicable for an acidic OER. In some aspects, the acidic media is sulfuric acid. In these different aspects, a proton exchange membrane (PEM) water electrolyzer comprises the OER catalyst.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF DRAWINGS

The present teachings will become more fully understood from the detailed description and the accompanying drawings wherein:

FIG. 1 illustrates a proton exchange membrane (PEM) water electrolysis reaction.

FIG. 2 illustrates a predicted tetragonal rutile structure of a Ru(M1M2M3M4)O₂ catalyst.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific examples within the scope of this technology. Further, certain aspects may incorporate features from a combination of figures.

### DETAILED DESCRIPTION

The present teachings relate to lattice doping to stabilize RuO₂ crystal structure, therefore improving activity and durability of RuO₂ based catalysts for oxygen evolution reaction in acidic media.

Lattice doping is intentional introduction of impurities into the atomic lattice of an undoped RuO₂ to modify its physical properties. Literature shows lattice doping seems to be an effective approach to stabilizing RuO₂ crystal structure, therefore improving its durability. Thus we searched for good dopants to improve stability of RuO₂ in the strong acid conditions. We did a high-throughput calculation using MATLANTIS™ machine learning potential to evaluate the stability of Ru_{0.75}(M1M2M3M4)_{0.25}O₂, where M1, M2, M3, M4 are selected from list [Cr, Mn, Fe, Co, Ni, Cu, Zn, Al, Ga, Ge, Mg, La] and M1, M2, M3, M4 have the same composition ratio. We calculate the energy required to remove one Ru atom from the structure and use it as the indicator for catalyst stability. A larger energy indicates a more stable structure. The instability of RuO₂ is due to its dissolution in the strong acid condition, removing one Ru atom mimics the dissolution process. We also calculate convex energy of each structure which can characterize the synthesizability of the corresponding structure.

In various aspects, the present teachings provide oxygen evolution reaction (OER) catalyst comprising:

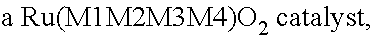

wherein the Ru(M1M2M3M4)O₂ catalyst comprises an M1, an M2, an M3 and an M4 co-doped in ruthenium oxide (RuO₂),
wherein M1 is chosen from Cr, Fe, Co, Ni, Cu, Zi, Al, Ga, Ge, Mg, La and combinations thereof,
wherein M2 is chosen from Cr, Fe, Co, Ni, Cu, Zi, Al, Ga, Ge, Mg, La and combinations thereof,
wherein M3 is chosen from Cr, Fe, Co, Ni, Cu, Zi, Al, Ga, Ge, Mg, La and combinations thereof, and
wherein M4 is chosen from Cr, Fe, Co, Ni, Cu, Zi, Al, Ga, Ge, Mg, La and combinations thereof.

In some aspects of the OER catalyst, Ru (ruthenium) ranges from about 20 at % to about 99 at %, the M1 ranges from about 0.25 at % to about 20 at %, the M2 ranges from about 0.25 at % to about 20 at %, the M3 ranges from about 0.25 at % to about 20 at %, and the M4 ranges from about 0.25% to about 20 at %.

In yet another aspect the OER catalyst is Ru_{0.75}(M1M2M3M4)_{0.25}O₂.

In yet another aspect of the OER catalyst, the M1, the M2, the M3 and the M4 are in an identical proportion or in the same composition ratio in the Ru(M1M2M3M4)O₂ catalyst.

Six (6) quaternary doped RuO₂ compounds with a higher dissolution energy (i.e., a higher stability) than undoped RuO₂ are disclosed. The six quaternary doped RuO₂ compounds were screened or identified with a high-throughput calculation using MATLANTIS™ machine learning software to evaluate the stability of Ru_{0.75}(M1M2M3M4)_{0.25}O₂, where M1, M2, M3, M4 were selected from the list of Cr, Mn, Fe, Co, Ni, Cu, Zn, Al, Ga, Ge, Mg, and La, and M1, M2, M3, M4 had the same composition ratio.

Six quaternary doped RuO₂ compounds are shown in Table 1 below.

TABLE 1

Ru_{0.75}(CrMnFeGe)_{0.25}O₂
Ru_{0.75}(CrMnAIGe)_{0.25}O
Ru_{0.75}(CrMnGaGe)_{0.25}O₂
Ru_{0.75}(CrFeGaGe)_{0.25}O₂
Ru_{0.75}(CrCoMgLa)_{0.25}O₂
Ru_{0.75}(NiCuZnLa)_{0.25}O₂

In yet another aspect, the OER catalyst is chosen from an Ru_{0.75}(CrMnFeGe)_{0.25}O₂ catalyst, an Ru_{0.75}(CrMnAlGe)_{0.25}O₂ catalyst, an Ru_{0.75}(CrMnGaGe)_{0.25}O₂ catalyst, an Ru_{0.75}(CrFeGaGe)_{0.25}O₂ catalyst, an Ru_{0.75}(CrCoMgLa)_{0.25}O₂ catalyst and an Ru_{0.75}(NiCuZnLa)_{0.25}O₂ catalyst.

In yet another aspect of the OER catalyst, an additional energy greater than 0 eV is required to remove one ruthenium (Ru) atom from the Ru(M1M2M3M4)O₂ catalyst as compared to undoped RuO₂.

In another aspect of the OER catalyst, an additional energy of about 2.189 eV is required to remove one ruthenium (Ru) atom from the Ru_{0.75}(CrMnFeGe)_{0.25}O₂ catalyst as compared to undoped RuO₂.

In another aspect of the OER catalyst, an additional energy of about 2.881 eV is required to remove one ruthenium (Ru) atom from the Ru_{0.75}(CrMnAlGe)_{0.25}O₂ catalyst as compared to undoped RuO₂.

In another aspect of the OER catalyst, an additional energy of about 4.526 eV is required to remove one ruthenium (Ru) atom from the Ru_{0.75}(CrMnGaGe)_{0.25}O₂ catalyst as compared to undoped RuO₂.

In another aspect of the OER catalyst, an additional energy of about 2.42 eV is required to remove one ruthenium (Ru) atom from the Ru_{0.75}(CrFeGaGe)_{0.25}O₂ catalyst as compared to undoped RuO₂.

In another aspect of the OER catalyst, an additional energy of about 1.585 eV is required to remove one ruthenium (Ru) atom from the Ru_{0.75}(CrCoMgLa)_{0.25}O₂ catalyst as compared to undoped RuO₂.

In another aspect of the OER catalyst, an additional energy of about 1.921 eV is required to remove one ruthenium (Ru) atom from the Ru_{0.75}(NiCuZnLa)_{0.25}O₂ catalyst as compared to undoped RuO₂.

Convex hull energy is the formation energy difference between an interested compound (also referred to as a compound that is of interest) and the most stable compound with the same composition as the interested compound. The smallest value for convex hull energy is 0 (when the interested compound is the most stable compound itself), the larger the value is, the less chance the interested compound can be synthesized because the interested compound has the tendency to decompose to the most stable compound. Usually 0.05 eV/atom is the widely-accepted threshold in the community, and any compound with convex hull energy in the range of [0, 0.05]eV/atom could be considered as synthesizable.

Six (6) quaternary doped RuO₂ compounds are disclosed which have a high synthesizability as shown by the convex hull energy. In some aspects of the OER catalyst, a convex hull energy of an Ru_{0.75}(CrMnFeGe)_{0.25}O₂ catalyst ranges from 0 eV/atom to about 0.05 eV/atom, a convex hull energy of an Ru_{0.75}(CrMnAlGe)_{0.25}O₂ catalyst ranges from 0 eV/atom to about 0.05 eV/atom, a convex hull energy of an Ru_{0.75}(CrMnGaGe)_{0.25}O₂ catalyst ranges from 0 eV/atom to about 0.05 eV/atom, a convex hull energy of an Ru_{0.75}(CrFeGaGe)_{0.25}O₂ catalyst ranges from 0 eV/atom to about 0.05 eV/atom, a convex hull energy of an Ru_{0.75}(CrCoMgLa)_{0.25}O₂ catalyst ranges from 0 eV/atom to about 0.05 eV/atom and a convex hull energy of an Ru_{0.75}(NiCuZnLa)_{0.25}O₂ catalyst ranges from 0 eV/atom to about 0.05 eV/atom.

In another aspect of the OER catalyst, the convex hull energy of the Ru_{0.75}(CrMnFeGe)_{0.25}O₂ catalyst is about 0.026 eV/atom, the convex hull energy of the Ru_{0.75}(CrMnAlGe)_{0.25}O₂ catalyst is about 0.045 eV/atom, the convex hull energy of the Ru_{0.75}(CrMnGaGe)_{0.25}O₂ catalyst is about 0.043 eV/atom, the convex hull energy of the Ru_{0.75}(CrFeGaGe)_{0.25}O₂ catalyst is about 0.048 eV/atom, the convex hull energy of the Ru_{0.75}(CrCoMgLa)_{0.25}O₂ catalyst is about 0.049 eV/atom and the convex hull energy of the Ru_{0.75}(NiCuZnLa)_{0.25}O₂ catalyst is about 0.02 eV/atom.

In another aspect of the OER catalyst, the Ru(M1M2M3M4)O₂ catalyst is a solid solution metal oxide.

In these different aspects of the OER catalyst, the OER catalyst comprises a tetragonal rutile-type structure.

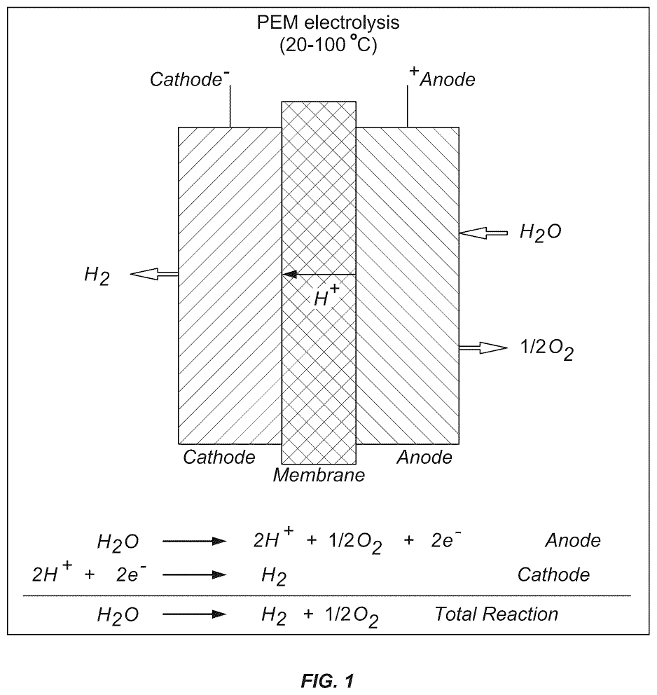

FIG. 1 illustrates a proton exchange membrane (PEM) water electrolysis reaction. An electrolyzer is an electrochemical device to convert electricity and water into hydrogen and oxygen, these gases can then be used as a means to store energy for later use. Proton exchange membrane (PEM) electrolysis is the electrolysis of water in a PEM water electrolyzer cell equipped with a solid polymer electrolyte that is responsible for the conduction of protons, separation of product gases, and electrical insulation of the electrodes. It involves a proton-exchange membrane.

The half reaction taking place on the anode side of a PEM water electrolyzer is referred to as the Oxygen Evolution Reaction (OER). Here the liquid water reactant is supplied to catalyst where the supplied water is oxidized to oxygen, protons and electrons:

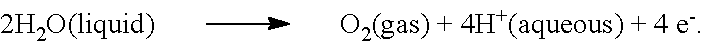

The half reaction taking place on the cathode side of a PEM water electrolyzer is the Hydrogen Evolution Reaction (HER), wherein the supplied electrons and the protons that have conducted through the membrane are combined to create gaseous hydrogen:

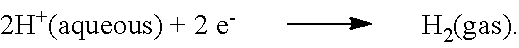

The total reaction is: H₂O(liquid)→H₂(gas)+½O₂(gas).

The OER catalyst is at an anode of a proton exchange membrane (PEM) water electrolyzer. In these different aspects, the OER catalyst is applicable for an acidic OER. In some aspects, the acidic media is sulfuric acid.

In these different aspects, a proton exchange membrane (PEM) water electrolyzer comprises the OER catalyst.

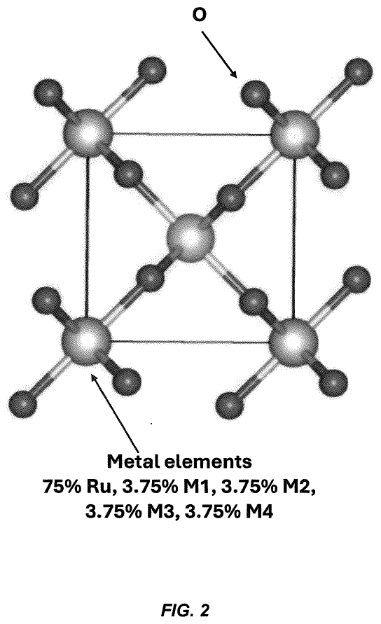

FIG. 2 provides a predicted tetragonal rutile structure of the Ru(M1M2M3M4)O₂ catalyst. The locations of Ru, 0, M1, M2, M3, and M4 are shown. The structure has 75% Ru, 3.75% M1, 3.75% M2, 3.75% M3 and 3.75% M4.

Further, the disclosure comprises additional notes and examples as detailed below.

### EXAMPLES

Various aspects of the present disclosure are further illustrated with respect to the following example. It is to be understood that this example is provided to illustrate specific examples of the present disclosure and should not be construed as limiting the scope of the present disclosure in or to any particular aspect.

### Example 1

A simulation analysis for doped RuO₂ was performed on MATLANTIS™ machine learning software to identify effect of lattice doping on undoped RuO₂ with Cr, Mn, Fe, Co, Ni, Cu, Zn, Al, Ga, Ge, Mg, and La having the same composition ratio (Ru_{0.75}(M1M2M3M4)_{0.25}O₂) for improving stability of the doped RuO₂ structure with high synthesizability.

Results in Table 2 summarizes data obtained from the MATLANTIS™ machine learning software for the six quaternary doped RuO₂ compounds that were screened and identified with a high-throughput calculation to evaluate the stability and synthesizability of Ru_{0.75}(M1M2M3M4)_{0.25}O₂, where M1, M2, M3, M4 were selected from the list of Cr, Mn, Fe, Co, Ni, Cu, Zn, Al, Ga, Ge, Mg, and La, and M1, M2, M3, M4 have the same composition ratio. Table 2 provides 1) additional energy (eV) required to remove one Ru atom from surface of material as compared to undoped RuO₂ indicates stability of the compound for acidic oxygen evolution reaction and 2) convex hull energy for (eV/atom) which indicates synthesizability of the compound. The six structures have higher dissolution energy (higher stability) than RuO₂ and high synthesizability as shown by the convex hull energy.

TABLE 2

| | Additional energy | |
|---|---|---|
| | (eV) required to | |
| | remove one Ru atom | |
| | from surface of | Convex Hull |
| | material as compared | Energy |
| Material | to undoped RuO₂ | (eV/atom) |
| Ru_{0.75}(CrMnFeGe)_{0.25} | 2.189 | 0.026 |
| Ru_{0.75}(CrMnAlGe)_{0.25} | 2.881 | 0.045 |
| Ru_{0.75}(CrMnGaGe)_{0.25} | 4.526 | 0.043 |
| Ru_{0.75}(CrFeGaGe)_{0.25} | 2.42 | 0.048 |
| Ru_{0.75}(CrCoMgLa)_{0.25} | 1.585 | 0.049 |
| Ru_{0.75}(NiCuZnLa)_{0.25} | 1.921 | 0.02 |

### CLAUSES

Clause 1. An oxygen evolution reaction (OER) catalyst comprising:

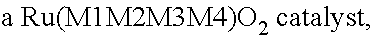

wherein the Ru(M1M2M3M4)O₂ catalyst comprises an M1, an M2, an M3 and an M4 co-doped in ruthenium oxide (RuO₂),
wherein M1 is chosen from Cr, Fe, Co, Ni, Cu, Zi, Al, Ga, Ge, Mg, La and combinations thereof,
wherein M2 is chosen from Cr, Fe, Co, Ni, Cu, Zi, Al, Ga, Ge, Mg, La and combinations thereof,
wherein M3 is chosen from Cr, Fe, Co, Ni, Cu, Zi, Al, Ga, Ge, Mg, La and combinations thereof, and
wherein M4 is chosen from Cr, Fe, Co, Ni, Cu, Zi, Al, Ga, Ge, Mg, La and combinations thereof.
Clause 2. The OER catalyst of clause 1, wherein Ru (ruthenium) ranges from about 20 at % to about 99 at %, the M1 ranges from about 0.25 at % to about 20 at %, the M2 ranges from about 0.25 at % to about 20 at %, the M3 ranges from about 0.25 at % to about 20 at %, and the M4 ranges from about 0.25% to about 20 at %.
Clause 3. The OER catalyst of clause 1, wherein the OER catalyst is Ru_{0.75}(M1M2M3M4)_{0.25}O₂.
Clause 4. The OER catalyst of clause 1, wherein the M1, the M2, the M3 and the M4 are in an identical proportion to each other in the Ru(M1M2M3M4)O₂ catalyst.
Clause 5. The OER catalyst of clause 1, wherein the OER catalyst is chosen from an Ru_{0.75}(CrMnFeGe)_{0.25}O₂ catalyst, an Ru_{0.75}(CrMnAlGe)_{0.25}O₂ catalyst, an Ru_{0.75}(CrMnGaGe)_{0.25}O₂ catalyst, an Ru_{0.75}(CrFeGaGe)_{0.25}O₂ catalyst, an Ru_{0.75}(CrCoMgLa)_{0.25}O₂ catalyst and an Ru_{0.75}(NiCuZnLa)_{0.25}O₂ catalyst.
Clause 6. The OER catalyst of clause 1, wherein an additional energy greater than 0 eV is required to remove one ruthenium (Ru) atom from the Ru(M1M2M3M4)O₂ catalyst as compared to undoped RuO₂.
Clause 7. The OER catalyst of clause 5, wherein an additional energy of about 2.189 eV is required to remove one ruthenium (Ru) atom from the Ru_{0.75}(CrMnFeGe)0.25O2 catalyst as compared to undoped RuO₂.
Clause 8. The OER catalyst of clause 5, wherein an additional energy of about 2.881 eV is required to remove one ruthenium (Ru) atom from the Ru_{0.75}(CrMnAlGe)0.25O2 catalyst as compared to undoped RuO₂.
Clause 9. The OER catalyst of clause 5, wherein an additional energy of about 4.526 eV is required to remove one ruthenium (Ru) atom from the Ru_{0.75}(CrMnGaGe)_{0.25}O₂ catalyst as compared to undoped RuO₂.
Clause 10. The OER catalyst of clause 5, wherein an additional energy of about 2.42 eV is required to remove one ruthenium (Ru) atom from the Ru_{0.75}(CrFeGaGe)_{0.25}O₂ catalyst as compared to undoped RuO₂.
Clause 11. The OER catalyst of clause 5, wherein an additional energy of about 1.585 eV is required to remove one ruthenium (Ru) atom from the Ru_{0.75}(CrCoMgLa)_{0.25}O₂ catalyst as compared to undoped RuO₂.
Clause 12. The OER catalyst of clause 5, wherein an additional energy of about 1.921 eV is required to remove one ruthenium (Ru) atom from the Ru_{0.75}(NiCuZnLa)_{0.25}O₂ catalyst as compared to undoped RuO₂.
Clause 13. The OER catalyst of clause 1, wherein a convex hull energy of an Ru_{0.75}(CrMnFeGe)_{0.25}O₂ catalyst ranges from 0 eV/atom to about 0.05 eV/atom, a convex hull energy of an Ru_{0.75}(CrMnAlGe)_{0.25}O₂ catalyst ranges from 0 eV/atom to about 0.05 eV/atom, a convex hull energy of an Ru_{0.75}(CrMnGaGe)_{0.25}O₂ catalyst ranges from 0 eV/atom to about 0.05 eV/atom, a convex hull energy of an Ru_{0.75}(CrFeGaGe)_{0.25}O₂ catalyst ranges from 0 eV/atom to about 0.05 eV/atom, a convex hull energy of an Ru_{0.75}(CrCoMgLa)_{0.25}O₂ catalyst ranges from 0 eV/atom to about 0.05 eV/atom and a convex hull energy of an Ru_{0.75}(NiCuZnLa)_{0.25}O₂ catalyst ranges from 0 eV/atom to about 0.05 eV/atom.
Clause 14. The OER catalyst of clause 13, wherein the convex hull energy of the Ru_{0.75}(CrMnFeGe)_{0.25}O₂ catalyst is about 0.026 eV/atom, the convex hull energy of the Ru_{0.75}(CrMnAlGe)_{0.25}O₂ catalyst is about 0.045 eV/atom, the convex hull energy of the Ru_{0.75}(CrMnGaGe)_{0.25}O₂ catalyst is about 0.043 eV/atom, the convex hull energy of the Ru_{0.75}(CrFeGaGe)_{0.25}O₂ catalyst is about 0.048 eV/atom, the convex hull energy of the Ru_{0.75}(CrCoMgLa)_{0.25}O₂ catalyst is about 0.049 eV/atom and the convex hull energy of the Ru_{0.75}(NiCuZnLa)_{0.25}O₂ catalyst is about 0.02 eV/atom.
Clause 15. The OER catalyst of clause 1, wherein the Ru(M1M2M3M4)O₂ catalyst is a solid solution metal oxide.
Clause 16. The OER catalyst of clause 1, wherein the Ru(M1M2M3M4)O₂ catalyst comprises a tetragonal rutile-type structure.
Clause 17. The OER catalyst of clause 1, wherein the Ru(M1M2M3M4)O₂ catalyst is at an anode of a proton exchange membrane (PEM) water electrolyzer.
Clause 18. The OER catalyst of clause 1, wherein the OER catalyst is applicable for an acidic OER.
Clause 19. The OER catalyst of clause 1, wherein OER activity is performed in an acidic media.
Clause 20. The OER catalyst of clause 19, wherein the acidic media is sulfuric acid.
Clause 21. A proton exchange membrane (PEM) water electrolyzer comprising the OER catalyst of clause 1.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple examples having stated features is not intended to exclude other embodiments having additional features, or other examples incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an example can or may comprise certain elements or features does not exclude other examples of the present technology that do not contain those elements or features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An oxygen evolution reaction (OER) catalyst comprising: 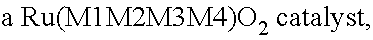
wherein the Ru(M1M2M3M4)O₂ catalyst comprises an M1, an M2, an M3 and an M4 co-doped in ruthenium oxide (RuO₂),
wherein M1 is chosen from Cr, Fe, Co, Ni, Cu, Zi, Al, Ga, Ge, Mg, La and combinations thereof,
wherein M2 is chosen from Cr, Fe, Co, Ni, Cu, Zi, Al, Ga, Ge, Mg, La and combinations thereof,
wherein M3 is chosen from Cr, Fe, Co, Ni, Cu, Zi, Al, Ga, Ge, Mg, La and combinations thereof, and
wherein M4 is chosen from Cr, Fe, Co, Ni, Cu, Zi, Al, Ga, Ge, Mg, La and combinations thereof.

2. The OER catalyst of claim 1, wherein Ru (ruthenium) ranges from about 20 at % to about 99 at %, the M1 ranges from about 0.25 at % to about 20 at %, the M2 ranges from about 0.25 at % to about 20 at %, the M3 ranges from about 0.25 at % to about 20 at %, and the M4 ranges from about 0.25% to about 20 at %.

3. The OER catalyst of claim 1, wherein the OER catalyst is Ru_{0.75}(M1M2M3M4)_{0.25}O₂.

4. The OER catalyst of claim 1, wherein the M1, the M2, the M3 and the M4 are in an identical proportion to each other in the Ru(M1M2M3M4)O₂ catalyst.

5. The OER catalyst of claim 1, wherein the OER catalyst is chosen from an Ru_{0.75}(CrMnFeGe)_{0.25}O₂ catalyst, an Ru_{0.75}(CrMnAlGe)_{0.25}O₂ catalyst, an Ru_{0.75}(CrMnGaGe)_{0.25}O₂ catalyst, an Ru_{0.75}(CrFeGaGe)_{0.25}O₂ catalyst, an Ru_{0.75}(CrCoMgLa)_{0.25}O₂ catalyst and an Ru_{0.75}(NiCuZnLa)_{0.25}O₂ catalyst.

6. The OER catalyst of claim 1, wherein an additional energy greater than 0 eV is required to remove one ruthenium (Ru) atom from the Ru(M1M2M3M4)O₂ catalyst as compared to undoped RuO₂.

7. The OER catalyst of claim 5, wherein an additional energy of about 2.189 eV is required to remove one ruthenium (Ru) atom from the Ru_{0.75}(CrMnFeGe)_{0.25}O₂ catalyst as compared to undoped RuO₂.

8. The OER catalyst of claim 5, wherein an additional energy of about 2.881 eV is required to remove one ruthenium (Ru) atom from the Ru_{0.75}(CrMnAlGe)_{0.25}O₂ catalyst as compared to undoped RuO₂.

9. The OER catalyst of claim 5, wherein an additional energy of about 4.526 eV is required to remove one ruthenium (Ru) atom from the Ru_{0.75}(CrMnGaGe)_{0.25}O₂ catalyst as compared to undoped RuO₂.

10. The OER catalyst of claim 5, wherein an additional energy of about 2.42 eV is required to remove one ruthenium (Ru) atom from the Ru_{0.75}(CrFeGaGe)_{0.25}O₂ catalyst as compared to undoped RuO₂.

11. The OER catalyst of claim 5, wherein an additional energy of about 1.585 eV is required to remove one ruthenium (Ru) atom from the Ru_{0.75}(CrCoMgLa)_{0.25}O₂ catalyst as compared to undoped RuO₂.

12. The OER catalyst of claim 5, wherein an additional energy of about 1.921 eV is required to remove one ruthenium (Ru) atom from the Ru_{0.75}(NiCuZnLa)_{0.25}O₂ catalyst as compared to undoped RuO₂.

13. The OER catalyst of claim 1, wherein a convex hull energy of an Ru_{0.75}(CrMnFeGe)_{0.25}O₂ catalyst ranges from 0 eV/atom to about 0.05 eV/atom, a convex hull energy of an Ru_{0.75}(CrMnAlGe)_{0.25}O₂ catalyst ranges from 0 eV/atom to about 0.05 eV/atom, a convex hull energy of an Ru_{0.75}(CrMnGaGe)_{0.25}O₂ catalyst ranges from 0 eV/atom to about 0.05 eV/atom, a convex hull energy of an Ru_{0.75}(CrFeGaGe)_{0.25}O₂ catalyst ranges from 0 eV/atom to about 0.05 eV/atom, a convex hull energy of an Ru_{0.75}(CrCoMgLa)_{0.25}O₂ catalyst ranges from 0 eV/atom to about 0.05 eV/atom and a convex hull energy of an Ru_{0.75}(NiCuZnLa)_{0.25}O₂ catalyst ranges from 0 eV/atom to about 0.05 eV/atom.

14. The OER catalyst of claim 13, wherein the convex hull energy of the Ru_{0.75}(CrMnFeGe)_{0.25}O₂ catalyst is about 0.026 eV/atom, the convex hull energy of the Ru_{0.75}(CrMnAlGe)_{0.25}O₂ catalyst is about 0.045 eV/atom, the convex hull energy of the Ru_{0.75}(CrMnGaGe)_{0.25}O₂ catalyst is about 0.043 eV/atom, the convex hull energy of the Ru_{0.75}(CrFeGaGe)_{0.25}O₂ catalyst is about 0.048 eV/atom, the convex hull energy of the Ru_{0.75}(CrCoMgLa)_{0.25}O₂ catalyst is about 0.049 eV/atom and the convex hull energy of the Ru_{0.75}(NiCuZnLa)_{0.25}O₂ catalyst is about 0.02 eV/atom.

15. The OER catalyst of claim 1, wherein the Ru(M1M2M3M4)O₂ catalyst is a solid solution metal oxide.

16. The OER catalyst of claim 1, wherein the Ru(M1M2M3M4)O₂ catalyst comprises a tetragonal rutile-type structure.

17. The OER catalyst of claim 1, wherein the Ru(M1M2M3M4)O₂ catalyst is at an anode of a proton exchange membrane (PEM) water electrolyzer.

18. The OER catalyst of claim 1, wherein the OER catalyst is applicable for an acidic OER.

19. A proton exchange membrane (PEM) water electrolyzer comprising the OER catalyst of claim 1.
